(19) United States
(12) Patent Application Publication
(10) Pub. No.: US 2018/0055090 A1
(43) Pub. Date: Mar. 1, 2018

(54) METHODS AND SYSTEMS FOR CARTRIDGE IDENTIFICATION

(71) Applicant: Altria Client Services LLC, Richmond, VA (US)

(72) Inventors: Christopher S. TUCKER, Midlothian, VA (US); Barry S. SMITH, Hopewell, VA (US); Sean SUNDBERG, Richmond, VA (US); Patrick J. COBLER, Nashua, NH (US)

(73) Assignee: Altria Client Services LLC, Richmond, VA (US)

(21) Appl. No.: 15/252,965

(22) Filed: Aug. 31, 2016

(51) Int. Cl. A24F 47/00; H05B 1/02

(52) U.S. Cl. CPC A24F 47/008; H05B 1/0244

(57) ABSTRACT

A cartridge configured to house a pre-vapor formulation for an e-vaping device, the cartridge including a connector having an anode and a cathode, and a nonpermanent conductive structure connecting the anode and the cathode, wherein the nonpermanent conductive structure is configured to break upon operation of the e-vaping device. A method of controlling usage of a cartridge in an e-vaping device, the e-vaping device including a battery connected to the cartridge, the method including providing a nonpermanent conductive structure between an anode of the cartridge and a cathode of the cartridge, the nonpermanent conductive structure being configured to break upon operation of the e-vaping device, detecting a resistance of the nonpermanent structure prior to operation of the e-vaping device, when the detected resistance is higher than a threshold resistance, preventing operation of the e-vaping device.

### BACKGROUND OF THE INVENTION

### Field of the Invention

Some example embodiments relate generally to a power supply and cartridge configuration for an electronic vaping device, and/or to a method of defining cartridge usage.

### Related Art

Electronic vaping devices are used to vaporize a liquid material into a vapor in order for an adult vaper to draw the vapor through outlet(s) of the e-vaping device. These electronic vaping devices may be referred to as e-vaping devices. An e-vaping device may typically include several e-vaping elements such as a power supply section and a cartridge. The power supply section includes a power source such as a battery, and the cartridge includes a heater along with a reservoir capable of holding the pre-vapor formulation or liquid material. The cartridge typically includes the heater in communication with the pre-vapor formulation via a wick, the heater being configured to heat the pre-vapor formulation to produce a vapor. The pre-vapor formulation typically includes an amount of nicotine as well as a vapor former and possibly water, acids, flavorants and/or aromas. The pre-vapor formulation includes a material or combination of materials that may be transformed into a vapor. For example, the pre-vapor formulation may include a liquid, solid and/or gel formulation including, but not limited to, water, beads, solvents, active ingredients, ethanol, plant extracts, natural or artificial flavors, and/or vapor formers such as glycerine and/or propylene glycol.

In other e-vaping devices, when the liquid pre-vapor formulation included in the reservoir runs out or is past the intended useful life of the cartridge, a residual amount of liquid pre-vapor formulation that may remain in the cartridge may undergo degradation and generate unwanted by-products. In addition, the pre-vapor formulation may overheat if the cartridge is utilized past the intended useful life of the power source of the e-vaping device. In addition, only a cartridge that has been originally manufactured for the e-vaping device can be used, according to various example embodiments.

### SUMMARY OF THE INVENTION

At least one example embodiment relates to a cartridge assembly of an e-vaping device.

In one example embodiment, the cartridge includes an anode and a cathode as well as a connector configured to be connected to another connected of a power source such as, for example, a battery. The anode and the cathode may be electrically connected to the anode and the cathode of the power source. The cartridge may further include a nonpermanent structure such as, for example, a low resistance wire, connecting the anode and the cathode of the cartridge together, thus creating a non-disabling short-circuit between the anode and the cathode of the cartridge.

In one example embodiment, the nonpermanent structure includes a low resistance wire connecting the cathode and the anode of the battery, effectively creating a small short between the anode and the cathode. Accordingly, upon connection of the battery to the cartridge, the battery detects a substantially small resistance between the anode and the cathode of the cartridge. The nonpermanent structure or wire is further configured to be ruptured upon the first activation of the e-vaping device, for example, upon the first puff. As a result of the rupture of the nonpermanent structure, detected by the disappearance of the non-disabling short circuit, the battery detects a larger resistance between the anode and the cathode of the cartridge, indicating that the device is being activated for the first time.

In one example embodiment, if the cartridge and the battery are separated and then re-connected, for example if the battery is removed in order to be replaced, or if the cartridge is recharged with additional pre-vapor formulation, then the wire between the anode and the cathode of the cartridge may rupture. As such, the battery may detect the rupture of the wire by detecting a higher resistance between the anode and the cathode of the cartridge than the expected detected resistance if the wire was not ruptured. Accordingly, the lack of detection of the low resistance in the wire signals the fact that the cartridge has already been previously used in the same or a different e-vaping device, or that the battery has been recharged. As a result, the e-vaping device may be shut down or otherwise prevented from operating. Thus, in example embodiments of an e-vaping device, the e-vaping device may be prevented from operating past a single battery charge or past a single cartridge use.

In one example embodiment, the battery is configured to emit a pulse to detect a resistance between the anode and the cathode. In example embodiments, the nonpermanent structure has a resistance of about 3 Ω. Accordingly, when the nonpermanent structure, such as the wire, is intact (i.e., non-ruptured), the resistance detected by the battery is about 3 Ω, and when the nonpermanent structure is ruptured, the detected resistance is substantially higher than 3 Ω.

In example embodiments, the e-vaping device may be shut down or otherwise prevented from operating by a processor included in the e-vaping device. The processor may be configured to prevent the heater from being powered by the battery, which would prevent the generation of vapor, and thus prevent the operation of the e-vaping device.

Example embodiments also relate to a method of controlling usage of a cartridge in an e-vaping device. In example embodiments, a nonpermanent structure such as a low-resistance wire is provided between an anode and a cathode of the cartridge, the nonpermanent structure being configured to rupture upon operation of the e-vaping device. A pulse may be generated from the battery of the e-vaping device to detect a resistance of the nonpermanent structure prior to or during operation of the e-vaping device. Accordingly, when the detected resistance is higher than a desired, or alternatively predetermined threshold, operation of the e-vaping device may be prevented.

In one embodiment, the e-vaping device may be prevented from operating by a processor included in the e-vaping device and configured to prevent the battery from powering the heater, thus preventing the formation of the vapor.

In example embodiments, the threshold resistance based on which the e-vaping device is prevented from operating may be about 3 Ω.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of an e-vaping device, according to an example embodiment;

FIG. 2 is a longitudinal cross-sectional view of an e-vaping device, according to an example embodiment;

FIG. 3 is a longitudinal cross-sectional view of another example embodiment of an e-vaping device;

FIG. 4 is a longitudinal cross-sectional view of another example embodiment of an e-vaping device;

FIG. 5 is a perspective view of a connecting portion for an e-vaping device, according to at least one example embodiment;

FIG. 6 is a perspective view of a connecting portion for an e-vaping device, according to at least one example embodiment; and

FIG. 7 is a flow chart illustrating a method of controlling multiple uses of a cartridge in an e-vaping device, according to various example embodiments.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations and/or elements, but do not preclude the presence or addition of one or more other features, integers, steps, operations, elements, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that precision of the geometric shape is not required but that latitude for the shape is within the scope of the disclosure. Although the tubular elements of the embodiments may be cylindrical, other tubular cross-sectional forms are contemplated, such as square, rectangular, oval, triangular and others.

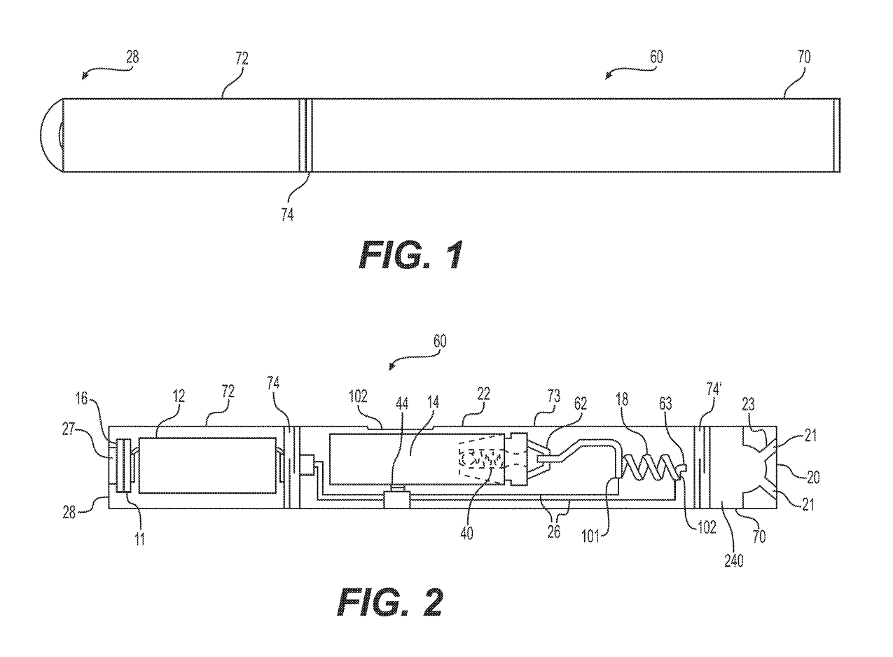

FIG. 1 is a side view of an e-vaping device or a “cigalike” device 60, according to an example embodiment. In FIG. 1, the e-vaping device 60 includes a first section or cartridge 70 and a second section 72, which are coupled together at a threaded joint 74 or by other connecting structure such as a snug-fit, snap-fit, detent, clamp and/or clasp or the like. In at least one example embodiment, the first section or cartridge 70 may be a replaceable cartridge, and the second section 72 may be a reusable section. Alternatively, the first section or cartridge 70 and the second section 72 may be integrally formed in one piece. In at least one embodiment, the second section 72 includes a LED at a distal end 28 thereof.

FIG. 2 is a cross-sectional view of an example embodiment of an e-vaping device. As shown in FIG. 2, the first section or cartridge 70 can house a mouth-end insert 20, a capillary capillary tube 18, and a reservoir 14.

In example embodiments, the reservoir 14 may include a wrapping of gauze about an inner tube (not shown). For example, the reservoir 14 may be formed of or include an outer wrapping of gauze surrounding an inner wrapping of gauze. In at least one example embodiment, the reservoir 14 may be formed of or include an alumina ceramic in the form of loose particles, loose fibers, or woven or nonwoven fibers. Alternatively, the reservoir 14 may be formed of or include a cellulosic material such as cotton or gauze material, or a polymer material, such as polyethylene terephthalate, in the form of a bundle of loose fibers. A more detailed description of the reservoir 14 is provided below.

The second section 72 can house a power supply 12, control circuitry 11 configured to control the power supply 12, and a puff sensor 16. The puff sensor 16 is configured to sense when an adult vaper is drawing on the e-vaping device 60, which triggers operation of the power supply 12 via the control circuitry 11 to heat the pre-vapor formulation housed in the reservoir 14, and thereby form a vapor. A threaded portion 74 of the second section 72 can be connected to a battery charger, when not connected to the first section or cartridge 70, to charge the battery or power supply section 12.

In example embodiments, the capillary tube 18 is formed of or includes a conductive material, and thus may be configured to be its own heater by passing current through the tube 18. The capillary tube 18 may be any electrically conductive material capable of being heated, for example resistively heated, while retaining the necessary structural integrity at the operating temperatures experienced by the capillary tube 18, and which is non-reactive with the pre-vapor formulation. Suitable materials for forming the capillary tube 18 are one or more of stainless steel, copper, copper alloys, porous ceramic materials coated with film resistive material, nickel-chromium alloys, and combinations thereof. For example, the capillary tube 18 is a stainless steel capillary tube 18 and serves as a heater via electrical leads 26 attached thereto for passage of direct or alternating current along a length of the capillary tube 18. Thus, the stainless steel capillary tube 18 is heated by, for example, resistance heating. Alternatively, the capillary tube 18 may be a non-metallic tube such as, for example, a glass tube. In such an embodiment, the capillary tube 18 also includes a conductive material such as, for example, stainless steel, nichrome or platinum wire, arranged along the glass tube and capable of being heated, for example resistively. When the conductive material arranged along the glass tube is heated, pre-vapor formulation present in the capillary tube 18 is heated to a temperature sufficient to at least partially volatilize pre-vapor formulation in the capillary tube 18.

In at least one embodiment, the electrical leads 26 are bonded to the metallic portion of the capillary tube 18. In at least one embodiment, one electrical lead 26 is coupled to a first, upstream portion 101 of the capillary tube 18 and a second electrical lead 26 is coupled to a downstream, end portion 102 of the capillary tube 18.

In operation, when an adult vaper draws on the e-vaping device, the puff sensor 16 detects a pressure gradient caused by the drawing of the adult vaper, and the control circuitry 11 controls heating of the pre-vapor formulation located in the reservoir 14 by providing power to the capillary tube 18. Once the capillary tube 18 is heated, the pre-vapor formulation contained within a heated portion of the capillary tube 18 is volatilized and emitted from the outlet 63, where the pre-vapor formulation expands and mixes with air and forms a vapor in mixing chamber 240.

As shown in FIG. 2, the reservoir 14 includes a valve 40 configured to maintain the pre-vapor formulation within the reservoir 14 and to open when the reservoir 14 is squeezed and pressure is applied thereto, the pressure being created when an adult vaper draws on the e-vaping device at the mouth-end insert 20, which results in the reservoir 14 forcing the pre-vapor formulation through the outlet 62 of the reservoir 14 to the capillary tube 18. In at least one embodiment, the valve 40 opens when a critical, minimum pressure is reached so as to avoid inadvertently dispensing pre-vapor formulation from the reservoir 14. In at least one embodiment, the pressure required to press the pressure switch 44 is high enough such that accidental heating due to the pressure switch 44 being inadvertently pressed by outside factors such as physical movement or collision with outside objects is avoided.

The power supply 12 of example embodiments can include a battery arranged in the second section 72 of the e-vaping device 60. The power supply 12 is configured to apply a voltage to volatilize the pre-vapor formulation housed in the reservoir 14.

In at least one embodiment, the electrical connection between the capillary tube 18 and the electrical leads 26 is substantially conductive and temperature resistant while the capillary tube 18 is substantially resistive so that heat generation occurs primarily along the capillary tube 18 and not at the contacts.

The power supply section or battery 12 may be rechargeable and include circuitry allowing the battery to be chargeable by an external charging device. In example embodiments, the circuitry, when charged, provides power for a given number of puffs, after which the circuitry may have to be re-connected to an external charging device.

In at least one embodiment, the e-vaping device 60 may include control circuitry 11 which can be, for example, on a printed circuit board. The control circuitry 11 may also include a heater activation light 27 that is configured to glow when the device is activated. In at least one embodiment, the heater activation light 27 comprises at least one LED and is at a distal end 28 of the e-vaping device 60 so that the heater activation light 27 illuminates a cap which takes on the appearance of a burning coal during a puff. Moreover, the heater activation light 27 can be configured to be visible to the adult vaper. The light 27 may also be configured such that the adult vaper can activate and/or deactivate the light 27 when desired, such that the light 27 is not activated during vaping if desired.

In at least one embodiment, the e-vaping device 60 further includes a mouth-end insert 20 having at least two off-axis, diverging outlets 21 that are uniformly distributed around the mouth-end insert 20 so as to substantially uniformly distribute vapor in an adult vaper's mouth during operation of the e-vaping device. In at least one embodiment, the mouth-end insert 20 includes at least two diverging outlets 21 (e.g., 3 to 8 outlets or more). In at least one embodiment, the outlets 21 of the mouth-end insert 20 are located at ends of off-axis passages 23 and are angled outwardly in relation to the longitudinal direction of the e-vaping device 60 (e.g., divergently). As used herein, the term “off-axis” denotes an angle to the longitudinal direction of the e-vaping device.

In at least one embodiment, the e-vaping device 60 is about the same size as a tobacco-based product. In some embodiments, the e-vaping device 60 may be about 80 mm to about 110 mm long, for example about 80 mm to about 100 mm long and about 7 mm to about 10 mm in diameter.

The outer cylindrical housing 22 of the e-vaping device 60 may be formed of or include any suitable material or combination of materials. In at least one embodiment, the outer cylindrical housing 22 is formed at least partially of metal and is part of the electrical circuit connecting the control circuitry 11, the power supply 12 and the puff sensor 16.

As shown in FIG. 2, the e-vaping device 60 can also include a middle section (third section) 73, which can house the pre-vapor formulation reservoir 14 and the capillary tube 18. The middle section 73 can be configured to be fitted with a threaded joint 74′ at an upstream end of the first section or cartridge 70 and a threaded joint 74 at a downstream end of the second section 72. In this example embodiment, the first section or cartridge 70 houses the mouth-end insert 20, while the second section 72 houses the power supply 12 and the control circuitry 11 that is configured to control the power supply 12.

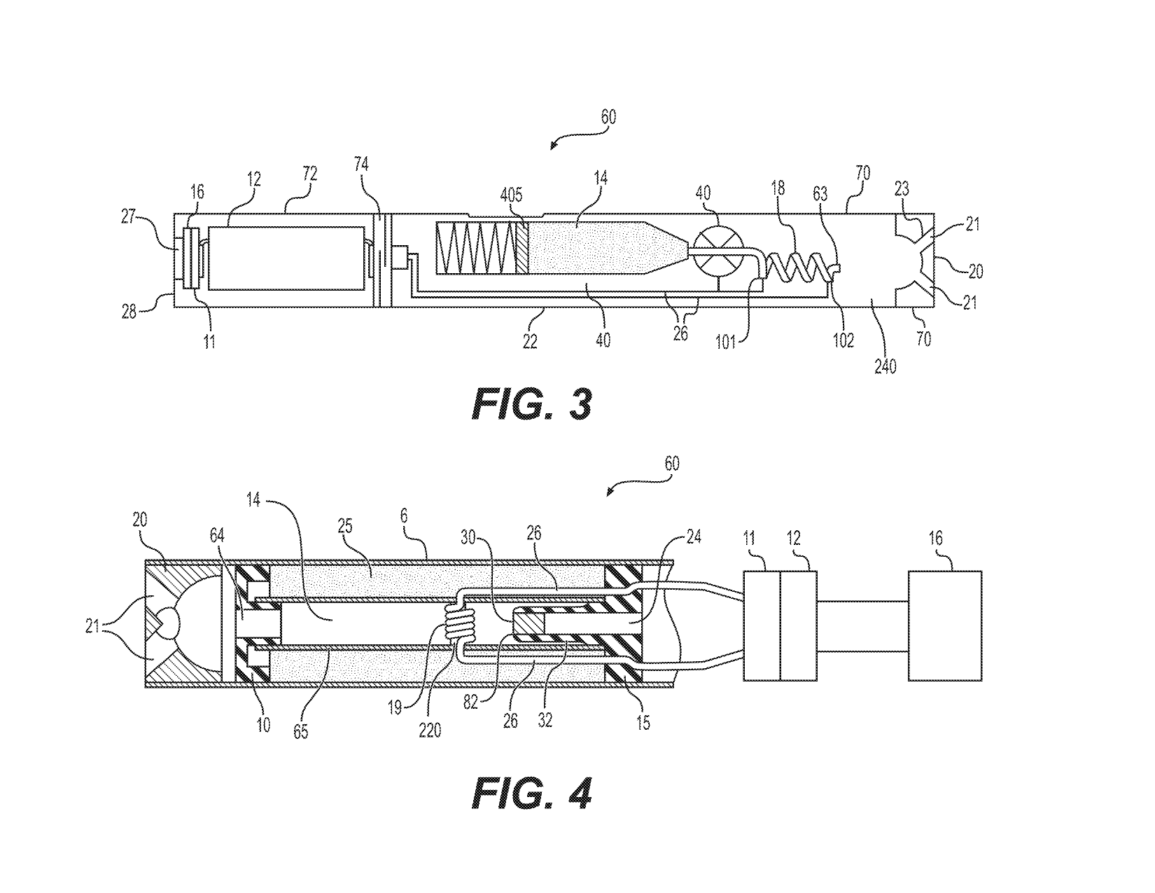

FIG. 3 is a cross-sectional view of an e-vaping device according to an example embodiment. In at least one embodiment, the first section or cartridge 70 is replaceable so as to avoid the need for cleaning the capillary tube 18. In at least one embodiment, the first section or cartridge 70 and the second section 72 may be integrally formed without threaded connections to form a disposable e-vaping device.

As shown in FIG. 3, in other example embodiments, a valve 40 can be a two-way valve, and the reservoir 14 can be pressurized. For example, the reservoir 14 can be pressurized using a pressurization arrangement 405 configured to apply constant pressure to the reservoir 14. As such, emission of vapor formed via heating of the pre-vapor formulation housed in the reservoir 14 is facilitated. Once pressure upon the reservoir 14 is relieved, the valve 40 closes and the heated capillary tube 18 discharges any pre-vapor formulation remaining downstream of the valve 40.

FIG. 4 is a longitudinal cross-sectional view of another example embodiment of an e-vaping device. In FIG. 4, the e-vaping device 60 can include a central air passage 24 in an upstream seal 15. The central air passage 24 opens to the inner tube 65. Moreover, the e-vaping device 60 includes a reservoir 14 configured to store the pre-vapor formulation. The reservoir 14 includes the pre-vapor formulation and optionally a storage medium 25 such as gauze configured to store the pre-vapor formulation therein. In an embodiment, the reservoir 14 is contained in an outer annulus between the outer tube 6 and the inner tube 65. The annulus is sealed at an upstream end by the seal 15 and by a stopper 10 at a downstream end so as to prevent leakage of the pre-vapor formulation from the reservoir 14. The heater 19 at least partially surrounds a central portion of a wick 220 such that when the heater is activated, the pre-vapor formulation present in the central portion of the wick 220 is vaporized to form a vapor. The heater 19 is connected to the battery 12 by two spaced apart electrical leads 26. The e-vaping device 60 further includes a mouth-end insert 20 having at least two outlets 21. The mouth-end insert 20 is in fluid communication with the central air passage 24 via the interior of inner tube 65 and a central passage 64, which extends through the stopper 10.

The e-vaping device 60 may include an air flow diverter comprising an impervious plug 30 at a downstream end 82 of the central air passage 24 in seal 15. In at least one example embodiment, the central air passage 24 is an axially extending central passage in seal 15, which seals the upstream end of the annulus between the outer and inner tubes 6, 65. The radial air channel 32 directing air from the central passage 20 outward toward the inner tube 65. In operation, when an adult vaper puffs on the e-vaping device, the puff sensor 16 detects a pressure gradient caused by the puffing of the adult vaper, and as a result the control circuitry 11 controls heating of the pre-vapor formulation located in the reservoir 14 by providing power the heater 19.

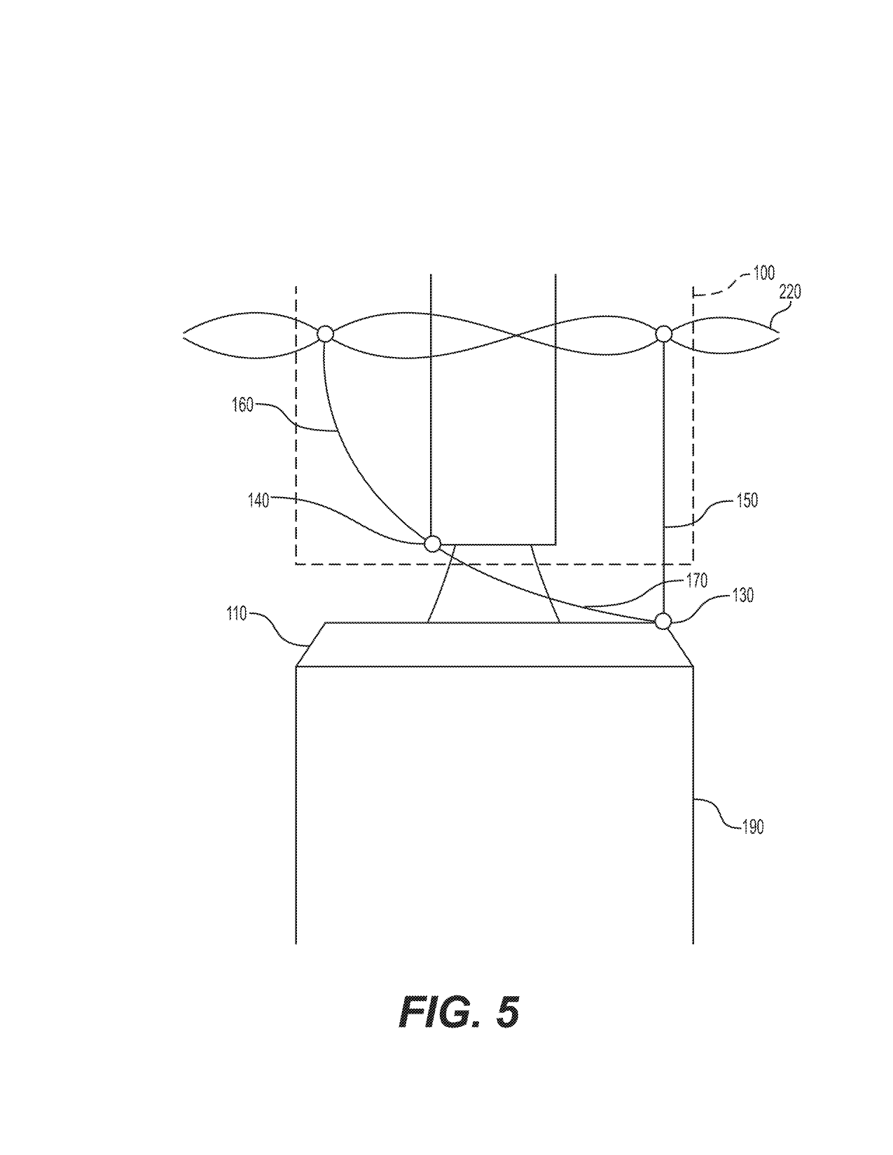

FIG. 5 is a perspective view of a connecting portion for an e-vaping device, according to at least one example embodiment. In FIG. 5, the connecting portion includes a battery connector 110 connecting the cartridge 100 to the power source or battery 190. In example embodiments, a cathode 130 and an anode 140 of the cartridge 100 are connected, respectively, via connection structures 150 and 160 such as wires, to a corresponding anode and cathode of the heater (not shown), where the heater is configured to heat up the pre-vapor formulation at the wick 220. In example embodiments, a nonpermanent structure 170 such as, for example, a low resistance wire, connect the cathode 130 and the anode 140, thus creating a non-disabling short circuit. The nonpermanent structure 170 may be configured to rupture or break upon the first activation of the e-vaping device, for example, upon the first draw on the e-vaping device by an adult vaper. When the battery 190 and the cartridge 100 are connected, the low resistance wire 170 is connected to the cathode 130 and to the anode 140 of the cartridge 100. As a result, the battery 190 detects a low resistance between the cathode 130 and the anode 140 because of the presence of the wire 170 connecting the anode 140 and the cathode 130 via, for example, the control circuitry 11 illustrated in FIGS. 2 and 3 and discussed with respect to FIG. 4. Thus, before the first operation of the e-vaping device, the battery 190 detects a non-disabling short-circuit between the cathode 130 and the anode 140, but after the first operation of the e-vaping device, the non-disabling short-circuit between the cathode 130 and the anode 140 is no longer detected, in which case operation of the e-vaping device may be interrupted via, for example, the control circuitry 11.

In one example embodiment, the wire 170 has a resistance of about 3 Ω. Thus, when the wire 170 is intact (i.e., non-ruptured), the detected resistance between the cathode 130 and the anode 140 of the cartridge 100 is about 3 Ω, and when the wire 170 is ruptured, for example upon the first activation of the e-vaping device or upon the first operation of the e-vaping device, the detected resistance between the cathode 130 and the anode 140 of the cartridge 100 becomes substantially higher than 3 Ω because the cathode 130 and the anode 140 of the cartridge are no longer connected by the wire 170.

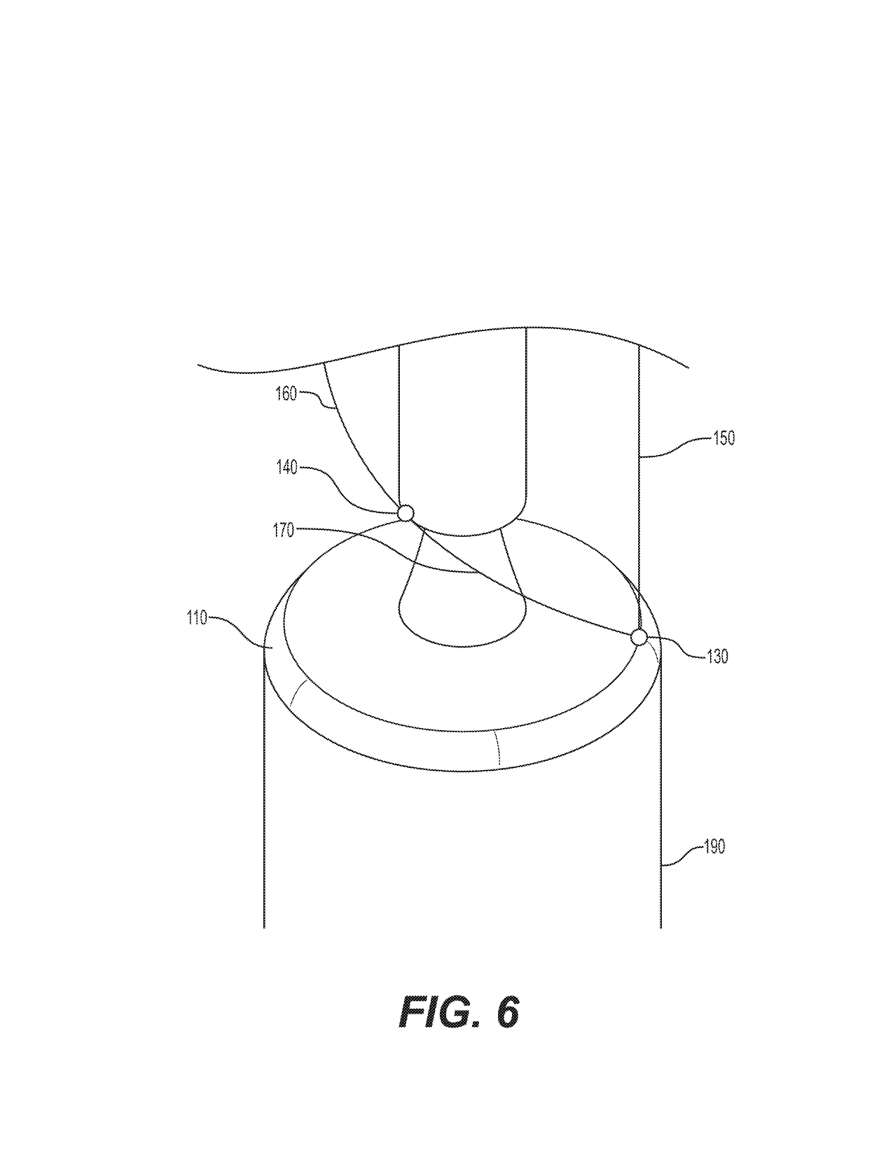

FIG. 6 is a detailed perspective view of a connecting portion for an e-vaping device, according to at least one example embodiment. In FIG. 6, the battery connector 110 is configured to connect the cartridge 100 to the power source container 190. In example embodiments, the cathode 130 and the anode 140 of the cartridge 100 are connected, respectively, via wires 150 and 160, to a corresponding anode and cathode of the heater (not shown).

In example embodiments, the wire 170 is connected to the cathode 130 and to the anode 140 of the cartridge 100, and when the battery is connected to the cartridge, the battery can detect a low resistance between the cathode 130 and the anode 140. In example embodiments, upon a first operation of the e-vaping device, the wire 170 is configured to rupture. As a result, once the e-vaping device has been used at least once and the wire 170 has been broken, if the cartridge 100 is removed from the e-vaping device, for example, to replenish the pre-vapor formulation inside the pre-vapor formulation container and is later re-inserted in the e-vaping device, the battery will no longer detect a low resistance of the wire 170 between the cathode 130 and the anode 140 when the power source 190 and the cartridge 100 are connected, and the e-vaping device may thus be prevented from operating by, for example, shutting off. Accordingly, unwanted multiple uses of the cartridge 100 may be avoided.

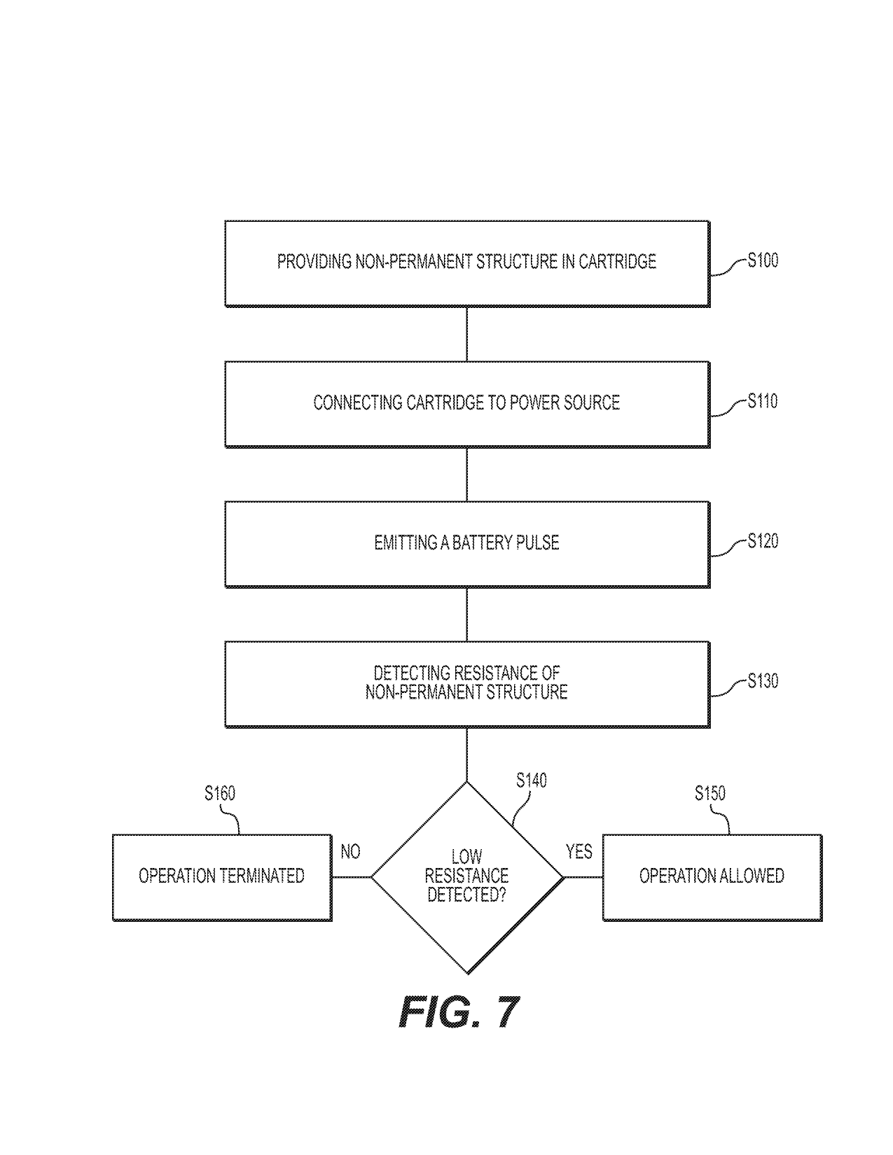

FIG. 7 is a flow chart illustrating a method of controlling multiple uses of a cartridge in an e-vaping device, according to various example embodiments. In FIG. 7, the method starts at S100, where the cartridge of an e-vaping device is provided with a non-permanent structure. For example, the anode and the cathode of the cartridge may be connected by the non-permanent structure in the form of a low resistance wire, thus forming a non-disabling short between the anode and the cathode of the cartridge. At S110, the cartridge is connected to a power source to form the e-vaping device. In example embodiments, the cartridge and the power source are connected via a connector, and the anode and cathode of the power source are connected to the anode and cathode of the cartridge so as to provide power to the heater included in the cartridge. At S120, upon connection of the cartridge with the power source, the power source such as, for example, a battery, emits a pulse to detect the resistance between the anode and the cathode of the cartridge. At S130, the resistance of the non-permanent structure such as, for example, a wire, is detected. In example embodiments, at S140, if the battery detects a low resistance, or a resistance that is equal to or lower than a threshold resistance which may be the resistance of the nonpermanent structure or wire, thus indicating that the wire is intact or in a non-ruptured state, then the method continues to S150 and the e-vaping device is allowed to continue to operate. If, however, the battery detects a resistance that is higher, or substantially higher, than the threshold resistance, indicating that the wire is ruptured, then the method continues to S160 and the e-vaping device is prevented from continuing to operate. For example, the e-vaping device is prevented from continuing to operate via a control circuitry. Accordingly, according to various example embodiments, the cartridge is prevented from operating past the useful life of the power source of the e-vaping device because the wire is configured to break upon the first puff of the e-vaping device. In addition, only a cartridge that has been originally manufactured for the e-vaping device can be used, according to various example embodiments.

Example embodiments having thus been described, it will be obvious that the same may be varied in many ways. Such variations are not to be regarded as a departure from the intended spirit and scope of example embodiments, and all modifications as would be obvious to one skilled in the art are intended to be included within the scope of the following claims.

What is claimed is:

1. A cartridge of an e-vaping device, the cartridge comprising:
a connector configured to connect an anode and a cathode of the cartridge with a power source; and
a nonpermanent conductive structure connecting the anode and the cathode together;
wherein the nonpermanent conductive structure is configured to rupture upon operation of the e-vaping device.

2. The cartridge of claim 1, wherein the nonpermanent conductive structure comprises a conducting wire.

3. The cartridge of claim 1, wherein the nonpermanent conductive structure has a resistance of about 3 Ω.

4. The cartridge of claim 1, wherein the cartridge is connected to the power source via the connector, and the anode and the cathode are respectively connected to an anode and a cathode of the power source.

5. The cartridge of claim 4, wherein the power source is configured to emit a pulse to detect a resistance between the anode and the cathode of the cartridge.

6. The cartridge of claim 5, wherein the nonpermanent conductive structure is configured to break upon a first operation of the e-vaping device.

7. The cartridge of claim 5, wherein when the nonpermanent conductive structure is ruptured, the detected resistance is substantially higher than a threshold resistance, and when the nonpermanent conductive structure is not ruptured, the detected resistance is equal to or lower than the threshold resistance.

8. The cartridge of claim 7, wherein the threshold resistance is equal to the resistance of the nonpermanent conductive structure.

9. A method of controlling usage of a cartridge in an e-vaping device, the e-vaping device including a power source connected to the cartridge, the method comprising:
providing a nonpermanent conductive structure between an anode of the cartridge and a cathode of the cartridge, the nonpermanent structure being configured to break upon operation of the e-vaping device;
detecting a resistance of the nonpermanent conductive structure; and
controlling usage of the cartridge based on the detected resistance of the nonpermanent conductive structure.

10. The method of claim 9, wherein when the detected resistance of the nonpermanent conductive structure is higher than a threshold resistance, controlling the usage of the cartridge comprises preventing operation of the e-vaping device.

11. The method of claim 10, wherein when the detected resistance of the nonpermanent conductive structure is equal to or lower than the threshold resistance, controlling the usage of the cartridge comprises allowing the operation of the e-vaping device.

12. The method of claim 9, wherein detecting the resistance of the nonpermanent conductive structure comprises generating a pulse from the battery.

13. The method of claim 9, wherein providing the nonpermanent conductive structure comprises providing a conducting wire between the anode and the cathode of the cartridge.

14. The method of claim 10, wherein the threshold resistance is about equal to the resistance of the nonpermanent conductive structure.

15. The method of claim 9, wherein preventing operation of the e-vaping device comprises:
determining that the detected resistance of the nonpermanent conductive structure is higher than the threshold resistance; and
preventing the power source from providing power to the cartridge via a processor included in the e-vaping device.
